(19) United States
(12) Patent Application Publication
(10) Pub. No.: US 2025/0376176 A1
(43) Pub. Date: Dec. 11, 2025

(54) ENERGY EFFICIENCY IN VEHICLE SENSOR SYSTEMS

(71) Applicant: Intel Corporation, Santa Clara, CA (US)

(72) Inventors: Cornelius BUERKLE, Karlsruhe (DE); Fabian OBORIL, Karlsruhe (DE)

(21) Appl. No.: 19/198,135

(22) Filed: May 5, 2025

(30) Foreign Application Priority Data
Jun. 7, 2024 (DE) 10 2024 115 982.0

(51) Int. Cl. B60W 50/00; B60W 30/18; G01S 17/931; H04N 23/667

(52) U.S. Cl. CPC B60W 50/0098; B60W 30/18163; G01S 17/931; B60W 2050/0083; B60W 2520/10; B60W 2552/10; B60W 2554/00; B60W 2556/65; H04N 23/667

(57) ABSTRACT

A sensor data manager for a vehicle comprises a processor, configured to receive vehicle status data or first data from a first sensor; to generate an instruction to change a setting of a second sensor or to change a data processing procedure for second data from the second sensor, based on the first data; wherein the second sensor is a sensor for use in a driving assistance operation; or wherein the data processing procedure is a data processing procedure for an automated driving function operation.

### CROSS-REFERENCE TO RELATED APPLICATIONS

This non-provisional patent application claims priority to German patent application 10 2024 115 982.0, filed on Jun. 7, 2024, the entire contents of which are incorporated herein by reference.

### TECHNICAL FIELD

Various aspects of this description generally relate to the management of sensors and the processing of sensor-generated data.

### BACKGROUND

With the increasing acceptance of electric vehicles (EVs) and in particular with the additional requirements that are placed on them, energy management (e.g. controlling energy consumption) is becoming increasingly important. Although energy management plays an important role in all vehicles, it is particularly important in electric vehicles, as the energy consumption directly affects the driving performance of the vehicle. It is expected that the power consumption of entertainment and driver assistance systems for vehicles with Advanced Driver Assistance Systems (ADAS) or Autonomous Driving (AD) will increase in the future, especially as more and more functions are being installed in the vehicles. The ADAS and AD functions in particular are likely to drive up power consumption, since more extensive assistance or autonomy (e.g. more capabilities for autonomous driving) is usually reliant on additional or more powerful sensors, which increases the computational effort required to process the corresponding sensor data.

### SHORT DESCRIPTION OF THE DRAWINGS

In the drawings, the same reference signs denote in general the same parts in the different views. The drawings are not necessarily to scale, with the focus being generally on illustrating the exemplary principles of the disclosure. In the following description, various exemplary embodiments of the disclosure are described with reference to the following drawings, in which:

FIG. 1 shows an example collection of regions around a vehicle, within which sensor data can be obtained;

FIG. 2 shows an exemplary setup and function of a component management system and a sensor management system according to an aspect of the disclosure;

FIG. 3 shows a determination of the area of relevance to a particular task by the component management system

FIG. 4 shows the examination of an area of interest in which a vehicle travels in the left lane of a road;

FIG. 5 shows the consideration of an area of relevance when an obstacle is present;

FIG. 6 shows the use of a power saving option for a long-distance sensor;

FIG. 7 shows the considerations when the main vehicle is traveling in the left lane behind another vehicle;

FIG. 8 shows the results of an analysis of the following distances on roads;

FIG. 9 shows an area of interest for an interchange assistance system;

FIG. 10 shows a junction to the interchange assistance system of FIG. 9;

FIG. 11 shows an area of interest calculated using a series of inputs;

FIG. 12 shows map data that indicate a road with a bend ahead;

FIG. 13 shows the consideration of regions that do not correspond to the road or the route when determining an area of interest;

FIG. 14 shows a vehicle approaching a bend;

FIG. 15 shows the consideration of the look-ahead time;

FIG. 16 shows an area of interest for an upcoming intersection

FIG. 17 represents the sensor data of a vehicle in field of view regions (visualized by triangles);

FIG. 18 shows the field of view of a medium-range sensor as a wide triangle extending out from the vehicle and the field of view of a long-range sensor as a narrow triangle extending out from the vehicle;

FIG. 19 shows the field of view of a left and right front-mounted LiDAR sensor of a vehicle in the form of triangles extending from the front corners of the vehicle;

FIG. 20 shows the fields of view of FIG. 17 to FIG. 19;

FIG. 21 shows a correlation between the field of view and the area of interest;

FIG. 22 shows a refinement of the information presented in FIG. 21 on the basis of a driving environment;

FIG. 23 shows the inclusion of buildings in a field of view calculation;

FIG. 24A shows a bounding box for the field of view with an altitude attribute;

FIG. 24B shows a leading vehicle that reduces its altitude relative to the main vehicle; and

FIG. 25 shows a sensor data manager for a vehicle.

### SPECIFICATION

The following detailed description refers to the accompanying drawings, which illustrate exemplary details and embodiments in which aspects of this disclosure may be put into practice.

The word “exemplary” is used here in the sense of “serving as an example, instance, or illustration”. Any embodiment or design described herein as “exemplary” is not necessarily to be understood as preferred or advantageous over other embodiments or designs.

Unless otherwise specified, the drawings will identify identical or similar elements, features and structures with the same reference numbers.

The expressions “at least one” and “one or more” can be understood to mean that they include a numeric amount greater than or equal to one (e.g., one, two, three, four, [ . . . ] etc.). The phrase “at least one of” with reference to a group of elements can be used here to mean at least one element from the group of elements. For example, the phrase “at least one of” can be used here with respect to a group of elements to mean a selection of: one of the listed items, a plurality of one of the listed items, a plurality of individual listed items, or a plurality of multiple individual listed items.

The words “plural” and “multiple” in the description and in the claims explicitly refer to a quantity greater than one. Accordingly, all expressions which expressly refer to the above-mentioned words (for example, “a plurality of [elements]”, “multiple [elements]”) refer to a set of elements, specifically to more than one of the stated elements. For instance, the wording “a plurality of” can be understood to mean that it includes a numeric amount greater than or equal to two (e.g., two, three, four, five, [ . . . ] etc.).

The expressions “group (of)”, “set (of)”, “collection (of)”, “series (of)”, “sequence (of)”, “grouping (of)”, etc. in the description and in the claims, if any, refer to a quantity equal to or greater than one, i.e. one or more. The terms “proper subset”, “reduced subset” and “smaller subset” refer to a subset of a set that is not equal to the set, for example a subset of a set that contains fewer elements than the set.

The term “data” used herein can be understood to mean that it includes information in any suitable analog or digital form, e.g., in the form of a file, a part of a file, a set of files, a signal or flow, a part of a signal or flow, a set of signals or flows, and the like. In addition, the term “data” can also be used for a reference to information, for example, in the form of a pointer. The term “data” is not restricted to the above-mentioned examples, however, and can assume various forms and represent any arbitrary information as understood in the technical world.

The terms “processor” or “controller” used here, for example, can be understood as any type of technological unit that allows data to be processed. The data can be processed according to one or more specific functions performed by the processor or control unit. Furthermore, a processor or control device as used herein can be understood to mean any type of circuit, e.g. any type of analog or digital circuit. A processor or control unit can therefore be or comprise an analog circuit, a digital circuit, a mixed signal circuit, a logic circuit, a processor, a microprocessor, a central processor (CPU), a graphics processing unit (GPU), a digital signal processor (DSP), a Field Programmable Gate Array (FPGA), an integrated circuit, an Application Specific Integrated Circuit (ASIC), etc., or any combination thereof. Any other form of implementation of the respective functions that is described in more detail below can likewise be understood to be a processor, controller, or logic circuit. It is evident that two (or more) of the processors, controllers or logic circuits described herein can be realized as a single unit of equivalent functionality or the like, and conversely that a single processor described herein, a single controller or logic circuit can be realized as two (or more) separate units of equivalent functionality or the like.

The term “memory” here denotes a computer-readable medium (e.g. a non-transient computer-readable medium) in which data or information can be stored for retrieval. When “memory” is mentioned here, it can mean a volatile or non-volatile memory, including a direct access memory (RAM), a fixed-value memory (ROM), a flash memory, a solid-state memory, a magnetic tape, a hard disk drive, an optical drive, a 3D XPoint™, or any combination thereof. Registers, shift registers, processor registers, data buffers, etc. are also grouped here under the term memory. The term “software” relates to all types of executable commands, including firmware.

If not expressly indicated, the term “transmission” includes both direct (point-to-point) and indirect transmission (via one or more intermediate points). Similarly, the term “receive” includes both direct and indirect reception. In addition, the terms “transmit”, “receive”, “communicate”, and similar terms include both physical transmission (for example, the transmission of radio signals) and logical transmission (for example, the transmission of digital data via a logic connection on the software level). For example, a processor or a control device can transmit or receive data via a connection on the software level to another processor or another control unit in the form of radio signals, wherein the physical transmission and the reception are handled by components of the radio layer such as HF transceivers and antennas and the logical transmission and the reception are carried out via the connection on the software level by the processors or control devices. The term “communicate” includes both transmitting and receiving, i.e. unidirectional or bidirectional communication in one or both directions, i.e. incoming and outgoing. The term “calculate” includes both “direct” calculations by means of a mathematical expression/a formula/a relationship and “indirect” calculations by means of lookup tables or hash tables and other array indexing or search operations.

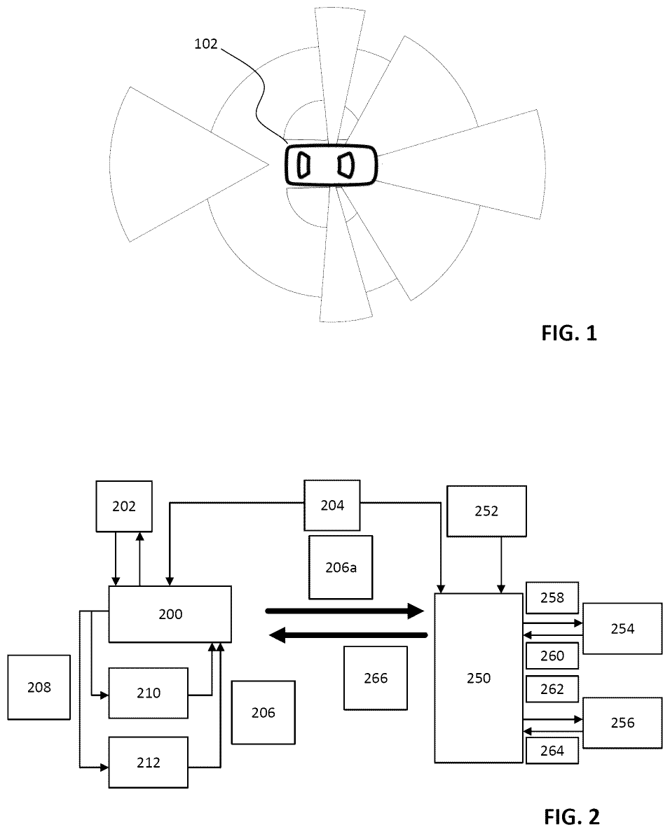

As already mentioned, it is desirable to improve energy management, especially in electric vehicles (e.g. to achieve energy savings). One way to improve energy efficiency is to turn off optional (e.g. unrequired) components or to put such components in a low-power mode. FIG. 1 shows an exemplary collection of regions around a vehicle from which sensor data for a specific vehicle 102 can be obtained. It should be noted that these regions are intended for illustrative purposes only and should not be understood necessarily to have a specific configuration or correspond to a specific type of vehicle. As can be seen, however, vehicles can usually be equipped with sensors that capture data from different sectors in front of the vehicle, different sectors behind the vehicle, and different sectors on each side of the vehicle. Each sector can correspond to one or more sensors of one or more sensor types. As a non-limiting example, a sector can be a Light Ranging and Detection (LiDAR) sensor, a camera, or a series of cameras, or both. Regardless of the configuration, the sensor system of an ADAS or AD vehicle has multiple sensors that generate data about the surroundings of the vehicle, and these sensors can include many different detection modalities, such as cameras and radar or LiDAR, as well as different detection distances (e.g. short range, such as when parking or overtaking other vehicles; medium range, as when driving in the city; and/or long range, as when driving on the highway). However, not all sensors are required or provide meaningful information for the current ADAS/AD task all the time, e.g. due to obstructions, weather conditions or an intended driving action.

An obvious example is a sensor with a long range in dense traffic. For example, if a nearby vehicle were to obstruct the sensor (e.g. an obstacle that reduces the area where the sensor can collect data), the long range of this sensor cannot be used properly. This means that the sensor may not be able to provide meaningful data for the ADAS/AD compared to a medium-range sensor. However, if the traffic becomes less dense (and in particular if there is no obstacle that obscures the sensor), the long-range sensor can capture data with a longer range and at the same time may be needed to track the environment. In other words, the detection requirements change depending on the situation.

Taking advantage of this fact, additional energy savings can be achieved by switching off the sensor and processing of the sensor data when they are not needed, or by otherwise adjusting a function or setting of the sensor, or by changing a quantity of its sensor data which is then processed, or the manner in which the sensor data is processed. This can be done while the ADAS/AD remains active and fully functional.

It is to be expected that the energy required for driving (e.g. the energy required for propelling and braking the vehicle) will remain substantially constant, but the scope of ADAS/AD functions is expected to increase significantly over time. This will lead to a new increase in energy demand, which will increase the importance of efforts to improve energy efficiency in other areas of the vehicle (e.g. outside the powertrain). In addition, energy savings can have a multiplier effect, as lower energy consumption (e.g. less energy demand) can lead to smaller batteries, which in turn can result in a lower weight and thus a lower energy consumption when driving.

Some vehicles have the ability to shut down entire components and the electronic control unit (ECU), but it is assumed that there is no mechanism available to optimize power consumption when the components are active. In other words: there is no automatic way to adjust the sensor settings or the processing depending on the situation or to realize energy savings in the sensor subsystem. For comparison: a modern electric vehicle requires 15-20.0 kWh per 100 km. If, for the sake of simplicity, it is assumed that the vehicle requires 15 kWh and travels at 30 km/h in an urban environment, the electric vehicle would require 5 kW/h. For example, if a multimodal sensor system with appropriate data processing capabilities requires about 1 kW/h, the sensor system makes up 20% of the total vehicle power consumption. Against this background, any contribution to reducing this energy demand can be useful.

Here, various strategies for energy saving by optimizing sensor utilization and sensor data processing based on the current driving situation are disclosed. These strategies are disclosed for illustrative purposes based on an energy management system that has two main components: (1) the component management system (CMS) and (2) the sensor management system (SMS). It should be noted at this point that the terms CMS and SMS are used here to clarify the underlying concept, but do not mean that two different clusters or processor groups are required. This means that the functions of CMS and SMS can also be performed by the same processor or cluster. In addition, these systems are described below with respect to sensors for environmental sensing such as cameras or LiDAR sensors, but the same system can also be used to control other sensors, such as GPS for localization.

FIG. 2 shows an exemplary configuration and function of a CMS 200 and an SMS 250 according to an aspect of the disclosure. The CMS 200 can be configured for bidirectional communication with the human-machine interface (HMI) 202, which allows it to receive user input and provide the user with messages (e.g. messages, signals, etc.). The HMI 202 connection allows the user to specify which sensors to turn on or off, to change to or leave a standby mode, or the power, resolution, or sampling rate of which can be changed. The CMC 200 may also receive map data from a map element 204 which may be or comprise a positioning sensor (e.g., a GPS sensor) or a positioning module, which is configured to determine a position of the vehicle based on a fundamental truth of the positioning (e.g., a last known position) and additional data that represent a movement, such as camera data, LiDAR data, accelerometer data, or the like.

The CMS 200 can be configured to manage the lifecycle and functionality of the system components. These can correspond to various ADAS/AD functions, such as lane maintenance, adaptive cruise control or emergency braking. The CMS 200 can contain an interface to these respective individual components (e.g. shown with arrows to and/or from the CMS 200) in order to exchange data (e.g. using existing technologies such as a Controller Area Network (CAN) bus).

If a component is to be run and/or activated by the user (e.g. as specified via the HMI 202), the CMS 200 can determine whether the operating domain (OD) 206 matches the current location. The OD, as used here, may refer to an area in the vicinity of the vehicle where the sensor generates appropriate sensor data. For example, a forward-facing LiDAR sensor may have an OD represented by a sector in front of the vehicle, and a side camera may have an OD represented by a sector (or a curve or other shape) extending from the side of the vehicle. For example, when determining whether the OD 206 matches the current location, the CMS 200 can use the map element 204 and/or location information. For example, an OD 206 for a “highway pilot” can specify that the OD 206 only works when the vehicle is on the highway and, for example, when minimum and maximum speed criteria are met. If these conditions are not met, the CMS 200 can decide to switch off the “highway pilot” (or one of its components) and optionally send a corresponding notification to the user (e.g. via the HMI).

If the OD requirements of the component are met, CMS can request a list 206 of required sensors/sensor data and optionally an area of interest. The area of interest can describe an area around the vehicle from which the sensors can obtain data (e.g. a road surface ahead of the vehicle, an adjacent lane, an area behind the vehicle, etc.). For example, a blind spot warning system can obtain data from the right and left of the vehicle, while a parking aid system can obtain data from rearward-facing sensors, etc.

In making these decisions, the CMS 200 can access additional sensor information 208, which may include, for example, a list of available sensors, a list of switched-on sensors, a list of switched-off sensors, status information (e.g. on, off, standby) of one of the available sensors and/or a list of all visible areas around the sensor.

The CMS 200 can have access to the various AF components. This is illustrated in such a way that the CMS 200 has access to the component A 210 and the component B 212, although in practice the number of components can be greater or less than two. A component as used here can describe a device or a collection of devices (e.g. processors, sensors, etc.) that perform a specific AF function. For example, a vehicle may contain a lane assistance component, a parking component, or something else.

The CMS 200 can also proactively request the activation of a component and the corresponding sensors. For example, if a user switches on a highway pilot and the navigation route or map indicates that the vehicle will soon enter a highway, the CMS 200 can activate all necessary systems proactively (e.g., in advance, before they are needed) to ensure they are ready for future use.

The CMS 200 can collect and merge information from all active components and share some or all of this information with the SMS. For example, the shared use of the OD, the areas of interest and/or required sensors is represented as 206a. In other words, the CMS 200 can provide a list of sensors Λₜₐₛₖ⊂Λₜₒₜₐₗ for the current driving task and user input, which can be a subset of all available sensors Λₜₒₜₐₗ. In addition, the CMS 200 can provide an area of interest Ω (to be monitored by the sensors), which can be represented as a closed polygon, with the property that (x,y)∉Ω⇔(x,y) “cannot contain any relevant information”.

The SMS 250 can be responsible for managing the sensors in the vehicle. As such, the SMS 250 can initially require a sensor description 252. This can contain the IDs of all or any available sensors as well as additional information such as the 6D position (x, y, z, roll, pitch and yaw or optionally any combination thereof) and the field of view (FOV) of the sensors (e.g. minimum range, maximum range, 3D opening angle, etc.).

The SMS 250 may be configured to identify usable, useful and/or essential sensors. For this purpose, it can use the requested sensors and the areas of interest from the CMS 200. The SMS 250 can then correlate the information about the area of interest with the map information. For each sensor (two sensors, sensor A 254 and sensor B 256, are shown here as examples, although the number of sensors for the SMS 250 may be greater or less than two), the SMS 250 can obtain an on/off status (or be configured to change the on/off status) and the field of view (FOV) of the sensor. The ON/OFF status of sensor A 254 is shown as 258 and the field of view of sensor A 254 is shown as 260; the On/Off status of sensor B 256 is shown as 262 and the field of view of sensor B 256 is shown as 264.

As a result, the SMS 250 can then provide a list of relevant and/or usable sensors 266 together with the corresponding areas of interest for the CMS. With regard to the above example, in which the vehicle is in the furthest left lane, SMS 250 can determine that the leftward-facing sensors do not provide useful information at this time, as the vehicle is already driving in the furthest left lane, and that the remote sensor is obscured by a vehicle in front and therefore does not provide any useful information either. In this way, the SMS 250 can determine whether the region is relevant to the current driving task.

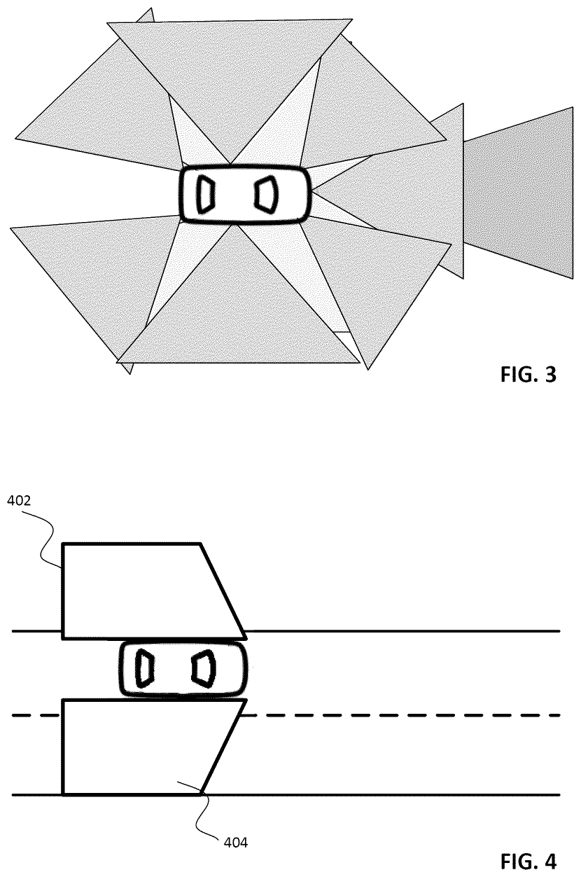

FIG. 3 illustrates how the CMS 200 determines the area of relevance for a task. In this illustration, the vehicle is driving in the middle lane of a highway. Sensor information about the front of the vehicle is of course relevant, as well as information about the areas to the left and right of the vehicle. In such a situation, however, information about areas directly behind the vehicle may be of minor importance or may even be considered irrelevant. In this case, if the CMS 200 provides the area of interest 22, which is represented as a closed polygon, with the property (x, y) ¢ 2=(x, y), it can return data that correspond to the polygon in FIG. 3 and show relevant information in front, to the left and right of the vehicle, but not an area of interest behind the vehicle.

Similarly, FIG. 4 shows the examination of an area of interest in which a vehicle travels in the left lane of a highway. In this figure, the vehicle is shown in such a way that it is equipped with sensors that capture information about an area on the left-hand side of the vehicle 402 and information about an area on the right-hand side of the vehicle 404. Since the information relating to an area on the right-hand side of the vehicle 404 corresponds to a traffic lane in which other vehicles may be approaching and/or a traffic lane in which the vehicle itself may enter, the area 404 is an area of interest. However, since the area on the left side of the vehicle corresponds to an area in which there is no lane and thus to an area in which one would not expect to encounter a vehicle or a relevant obstacle, the area to the left side of the vehicle 402 does not correspond to any area of interest.

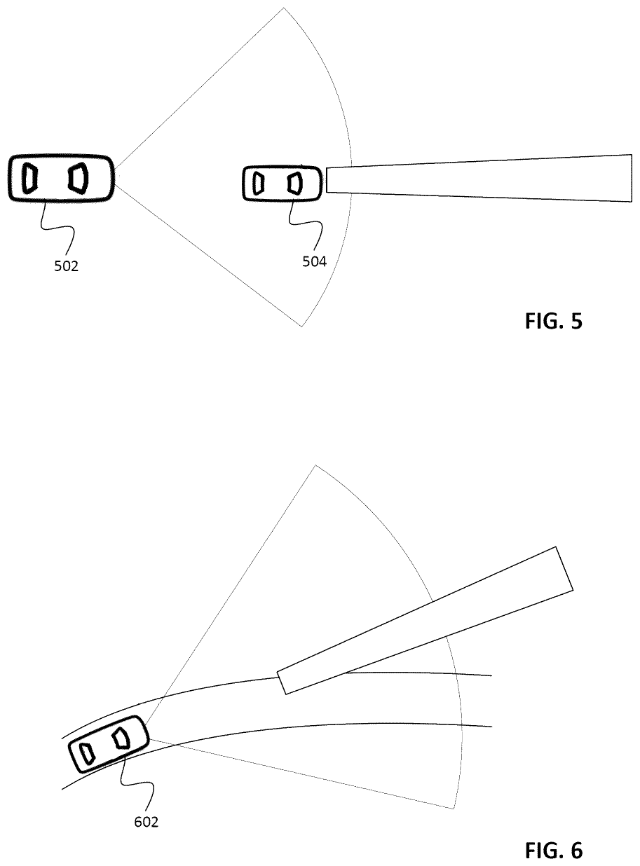

For a relevant area of interest, the given/requested sensor information can be reviewed. For example, it may be the case that the long-distance sensor cannot be used because another road user is blocking the vehicle (e.g., the long-distance sensor). For illustration, FIG. 5 shows the examination of an area of relevance in the presence of an obstacle. In this figure, the primary vehicle 502 is driving with an obstacle 504 in front of it (in this case another vehicle). The vehicle 502 has long-distance sensors which are configured to monitor an area at a great distance in front of the primary vehicle 502. However, the long-distance sensors are largely obscured by the obstacle 504, which reduces the benefit of the long-distance sensors. Therefore, only the mid-range sensor might be relevant for the region in question. Therefore, the primary vehicle 502 can deactivate the long-distance sensors or take another energy-saving measure with regard to the long-distance sensors (e.g. put them into standby mode, reduce the resolution, reduce the sampling rate, reduce the amount or frequency of the processed long-distance sensor data, etc.).

As another example, FIG. 6 shows the use of energy-saving options for a long-distance sensor as in FIG. 5, but based on a driving path and not on an obscured area. In this figure, the primary vehicle 602 is driving on a road, and its expected driving path is curved to the right. The primary vehicle 602 is in turn equipped with a long-distance sensor, which is capable of acquiring information about a distance in front of the vehicle. As the vehicle driving path changes (e.g. due to the bend), information about an area in front of the vehicle (e.g. in a straight line in front of the vehicle before the vehicle turns off), but at a large distance, is no longer relevant. In this situation, the primary vehicle may decide to perform an energy saving measure in relation to the long-distance sensor.

Once the area of relevance or area of interest is identified, this information can be used in at least two ways. First, the SMS 250 can report the visible region back to the SMS 200 (see message 266), which may be a subset of the area of interest, i.e. Ω_{visible}⊂Ω. In addition, the SMS 250 can send a list of sensors (e.g. optionally contained in 266) to the CMS 200, which provide meaningful data, i.e. Λ_{meaningful}⊂Λ⊂Λₒᵥₑᵣₐₗₗ. Based on this data, the CMS 200 can decide whether to put an entire component into a standby state or a shutdown state.

As an example, and with regard to a left-side blind spot system, the SMS 250 can send a list to CMS 200 indicating that the left-hand sensors for the blind spot system do not provide any information of interest, e.g. if the vehicle is traveling in the furthest left lane.

In addition, the SMS 250 can switch off the sensors, optionally with confirmation by the CMS, i.e. for S∈A the sensors can be switched off. The SMS 250 can notify such actions to the CMS 200 and its components, which may also be configured to confirm the message. If a component does not allow shutdown, the sensor may remain active. Alternatively, corrupted sensor data (e.g. an empty object list) can be provided as a replacement in order to switch off the corresponding sensor.

As explained above, the components and sensors have an operating range (e.g. a situation in which the components and/or sensors operate as in a specific environment, on a certain type of road, at a certain speed or speed range, etc.), which must be observed by the CMS 200 and SMS 250. In a configuration, components and/or sensors can be switched off if their OD is not observed. Alternatively, the components and/or sensors can be put into standby mode or their resolutions or sample rates can be changed. For example, a GPS sensor can be switched off when it enters an enclosure (i.e. the enclosure is not part of the operating range of the GPS sensor) because the GPS sensor cannot receive the required satellite signals while the vehicle is in the enclosure, providing an opportunity to save power. The enclosure could be, for example, a tunnel, an underground car park, a parking lot with poor visibility, etc. Similarly, a highway pilot can be turned off when leaving the highway.

According to another aspect of the disclosure, and in light of the underlying assumption that the components should be operational when excess weight is reached, it may be necessary to turn on certain components before the vehicle reaches excess weight. This is because certain sensors or components require at least a certain start-up time, and therefore the sensor or component must be switched on in good time to provide sufficient functionality before the OD is reached. The ideal switch-on and switch-off times can be calculated by predicting the navigation system and the required boot-up time of the components.

In an optional device, it may also be possible to take into account the driving intention of the vehicle. This is possible, for example, with a driving system of level L3 or higher. Such systems can include a destination and a route and even intentions of a navigation or driving system. These can be taken into account when selecting whether a sensor or component should be switched on or off, whether the resolution or sampling rate of a sensor should be changed, or whether sensor data should be processed (or to what extent). For example, if a vehicle driving in the left-hand lane intends to stay in that lane, it may be possible to turn off one or more sensors that acquire information about the right-hand lane. It behaves similarly if a vehicle intends to turn right in the next 20 meters. In this case, it may be possible to switch off a sensor for long distances (e.g. a sensor for detecting distances much larger than 20 meters in front of the vehicle).

In another optional configuration, and if the vehicle has an Adaptive Cruise Control (ACC) or similar feature and the user sets the ACC to a specific speed, sensors that do not contribute to the safety range of the vehicle can be disabled. For example, if the vehicle is traveling at a speed of 80 km/h, the safety range of the vehicle extends approximately 30 to 40 meters in front of the vehicle. Therefore, medium-range sensors are sufficient and a long-range sensor could be disabled.

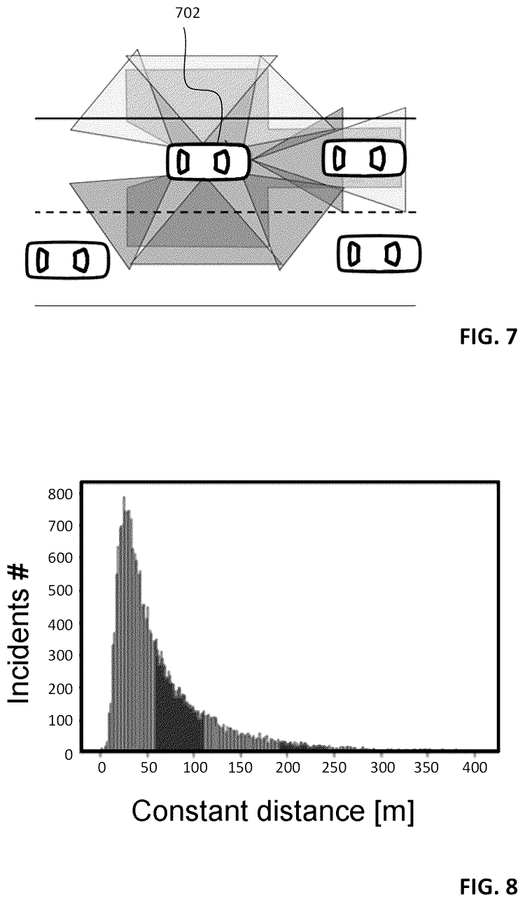

In an optional configuration, the areas of interest can be weighted. That is, although it may be desirable to maintain multiple areas of interest, they may not all have the same degree of interest. This is shown at least in FIG. 7, in which the primary vehicle 702 is driving in the far left lane behind another vehicle. Since the primary vehicle 702 is in the furthest left lane, information to the left of the vehicle—which in this example is not entirely ignored—may be of less interest than information to the right of the vehicle.

Although the area in front of the vehicle may generally be of great interest, this area is obscured by a vehicle driving ahead, limiting the area of interest to an area either a short or medium distance in front of the primary vehicle 702. However, areas that are far ahead of the primary vehicle 702 may be of little or no interest, as very little information can be obtained about such areas due to the concealment.

To illustrate the fact that such cases, in which sensors can be deactivated, are not only rare exceptions, an analysis was carried out with an Autobahn data set from Germany recorded by drone. FIG. 8 shows the results of this analysis and shows that in more than 50% of all cases the distance between vehicles was less than 50 meters. In other words: even when driving on the highway and in more than half the journey time, a long-distance sensor does not provide any additional information due to the concealment by a vehicle ahead.

Additional efforts are made below to describe an area of interest (AoI) calculation according to one aspect of the disclosure. The AoI can play a particularly important role in certain configurations because the sensor adjustment can be configured so as to strongly depend on the AoI. Firstly, each component can determine its own AoI. The overall AoI can then be determined as a union of all individual AoIs. However, since this union could lead to a non-optimal shape, it is possible to determine the AoI from the convex envelope curve over all AoIs. In the simplest case, however, the following applies:

$$AoI = {⋃}_{i} {AoI}_{i} \qquad ( 1 )$$

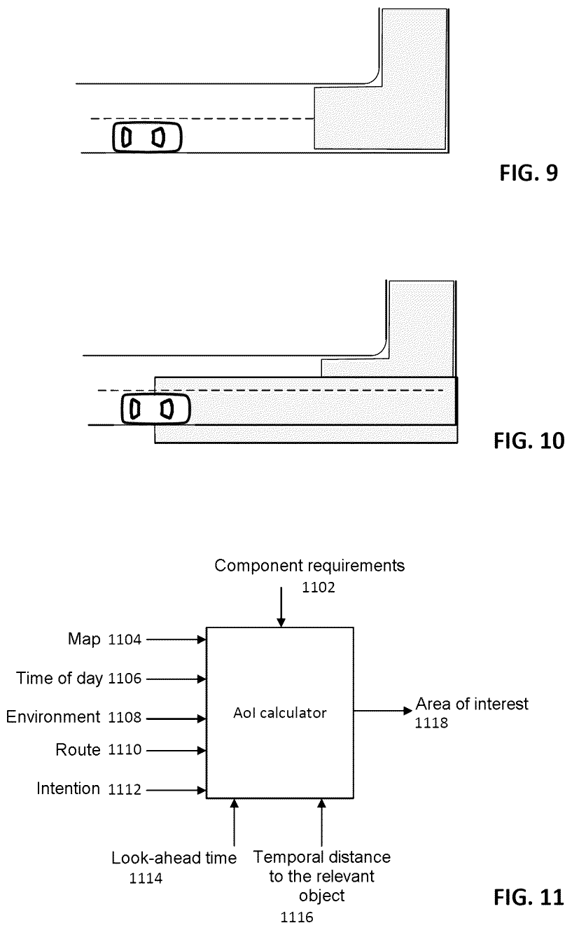

FIG. 9 shows, for example, an area of interest for an interchange assistance system in which the vehicle meets an intersection where it can turn off. FIG. 10 shows a combination of the interchange assistance system of FIG. 9 with the area of interest for an ACC.

In general, the AoI can be calculated using any number of inputs, as shown in FIG. 11. In this exemplary AoI computer, the AoI computer is configured to meet component requirements 1102, map 1104, time 1106, environment 1108, route 1110, intention 1112, look-ahead time 1114 and time interval to the relevant object 1116. The AoI computer may be configured to display an area of interest 1118 on the basis of one or more of these elements. It is explicitly pointed out that the AoI computer described here can be a standalone module, combined with other modules or implemented in software. To return briefly to these inputs, the first input is the component request, e.g. the area in front of the vehicle for ACC or a lane departure assistant. This requirement can define the initial form of the AoI, which can then be further refined using the other inputs.

In an example device, a first step of the AoI calculation may be to intersect the base AoI with the map (or the lane information of a lane recognition system). Anything that does not relate to a part of the road and the sidewalk can be removed from the AoI. If the system is in self-driving mode, this can even be extended to the route. In other words:

$${AoI}_{i , map + route} = {AoI}_{i , base} ⋂ Route ⋂ Map \qquad ( 2 )$$

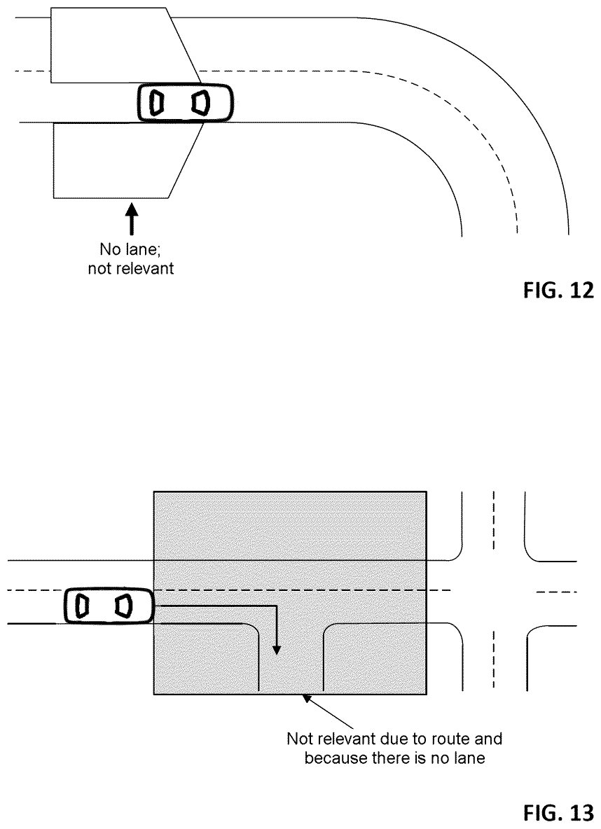

FIG. 12 and FIG. 13 show examples of the method. In FIG. 12 the map data indicate a road with a bend ahead. The vehicle is in the right-hand lane. The regions to the left of the vehicle correspond to a lane of the road and are therefore within the AoI. However, the regions to the right of the vehicle do not correspond to the road or to any area where traffic would be expected, and are therefore not included in the AoI. FIG. 13 shows a similar concept, in which regions are removed from the AoI because they do not correspond to the road or the route. In FIG. 13 the vehicle intends to follow a route indicated by the shaded region along the road (for example, it intends to turn right at the next intersection). The lanes on the road in front, but after the next intersection where the turning maneuver is to be made, are not part of the AoI, because the vehicle does not expect to be in that part of the road.

Under certain circumstances, some of the regions may have time-dependent attributes. A common problem in wooded areas, for example, is that animals may cross the road at night. Therefore, it may be preferable to include roadside regions in the AoI at critical times (e.g. in periods where animals are more likely to cross the road; at night), while these can be ignored at other times.

A potential problem with this refined AoI is that it can be a little long, depending on the length of the route. In most cases, the AoI will be much longer than the range of the sensors. Therefore, it may be desirable to further reduce the AoI. For this purpose, it may be desirable to implement a speed-dependent metric look-ahead time (LT). The LT can be understood as a contingency or option of a component that reflects a desired length (or width) of the AoI. For example, an ACC system must monitor at least the safety distance (+margin) in front of the vehicle. As a result, the AoI can be further refined as follows:

$${AoI}_{i , LT} = {AoI}_{i , route + m a p} ⋂ f ( L T ) \qquad ( 3 )$$

In this way, f(LT) can be a mapping function that relates the look-ahead time and the current vehicle speed (and optionally also assumptions about the speeds of other vehicles) to calculate a distance (e.g. to calculate a geometric shape).

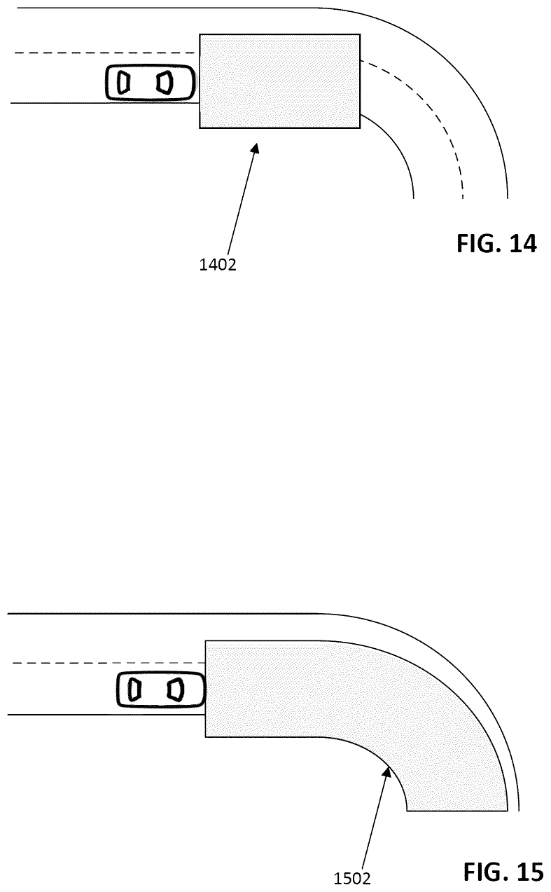

FIG. 14 and FIG. 15 show LT in relation to the AoI. FIG. 14, for example, shows a vehicle approaching a bend. Based on the speed and reaction time of the vehicle, the LT is calculated at 2 seconds. At the current speed of the vehicle, 2 seconds corresponds to a distance indicated by the shaded rectangle 1402. Similarly, in FIG. 15 the LT is calculated at 4 seconds (e.g. based on the speed and reaction time of the vehicle), and this corresponds to a much longer section of the road, as indicated by 1502.

After calculating the LT, it may be desirable to consider the surrounding objects. In this way, the time interval to the next relevant object (THWO) can be calculated. The THWO can be similar to the LT; for example, if an object is detected within the defined THWO when using ACC, the AoI can be further reduced to end with this vehicle, since anything in front of this vehicle would not be relevant to this component. The THWO can be calculated as follows:

$${AoI}_{i , THWO} = {AoI}_{i , LT} ⋂ g ( T H W O ) \qquad ( 4 )$$

where g, similar to f, maps the time into space, taking into account the speed of the vehicle and restrictions on the speed of the other objects.

It is possible to further refine the AoI based on the vehicle intention. For example, if an L3+ system is active, the driving system will know whether a lane change is planned. If no lane change is planned, any area to the left or right of the vehicle within the AoI could be removed. This can be represented as follows:

$${AoI}_{i , intent} = {AoI}_{i , T H W O} ⋂ intent\_region \qquad ( 5 )$$

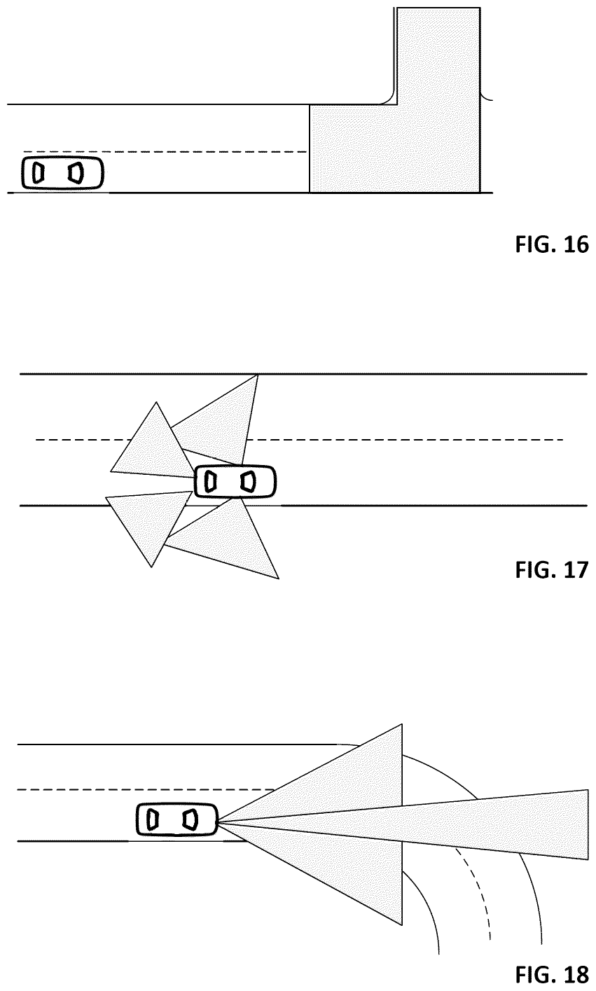

In an optional configuration, the AoI can also be increased for safety purposes. In other words, the above statements explain various strategies for reducing the size of a possible intersection zone. However, for safety reasons, it may be advisable to increase the AoI. To understand this, we consider an example in which the primary vehicle drives with a switched-off interchange assistance component (e.g. to save energy). The vehicle is approaching an intersection and the intersection becomes part of the initial AoI, as shown in FIG. 16, which shows an AoI for an upcoming intersection. The problem is that the interchange assistant must be turned on before the vehicle reaches the intersection. Therefore, a pre-processing step can be added for disabled components, which increases the AoI. This may force the SMS to activate the required sensors. This is illustrated by the following formula:

$${AoI}_{i , base}^{′} = {AoI}_{i , base} ⋃ h ( TSW ) \qquad ( 6 )$$

where TSW is the wake-up time of the components and sensors and h converts this time into the (geometric) distance range based on the vehicle speed.

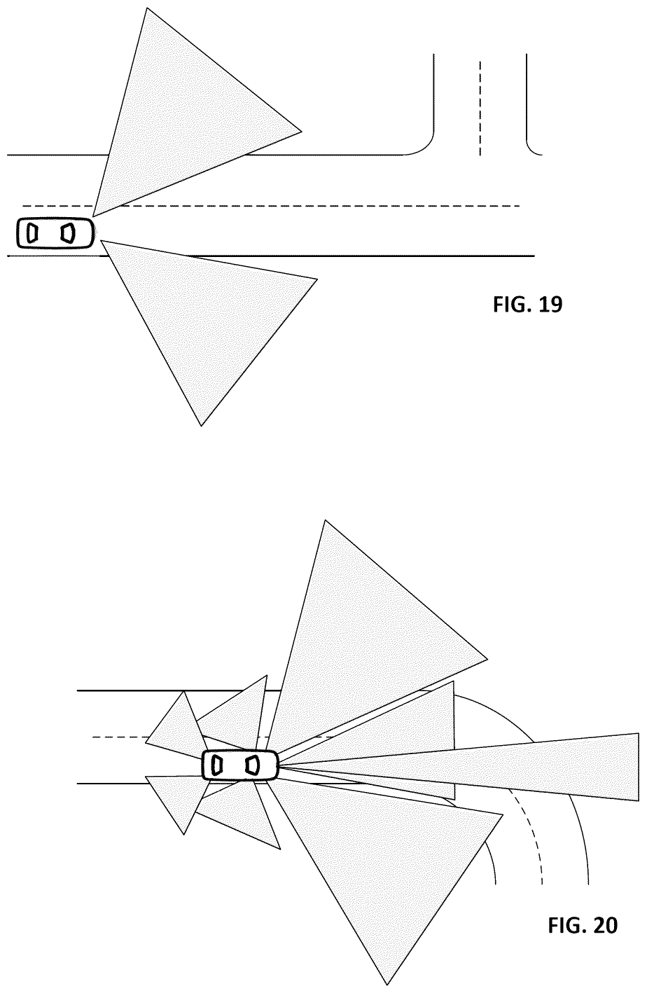

In the comments above, the AoI was described as a geometric polygon along driving lanes or road sections. In an additional processing step, the actual field of view of the sensor (FOV) can be included. The field of view of the sensor is shown in FIG. 17 to FIG. 20. In FIG. 17, the field of view of the sensors (e.g. in this case the LiDAR sensors) appears as a plurality of triangles emanating from the vehicle. In FIG. 18 the FOV of the middle sensor is shown as a wide triangle extending out from the vehicle and the FOV of the long-distance sensor is shown as a narrow triangle extending out from the vehicle. In FIG. 19, the FOV for each of the left and right front LiDAR sensors of the vehicle is shown as a triangle extending out from the front corners of the vehicle. In FIG. 20 the individual fields of view of FIG. 17 to FIG. 19 are combined into a single image.

In a next step, the components can provide the information about the desired sensor set. This could be, for example, the ID of the required sensors. The connection between the ID and the sensor must be established when the vehicle is configured.

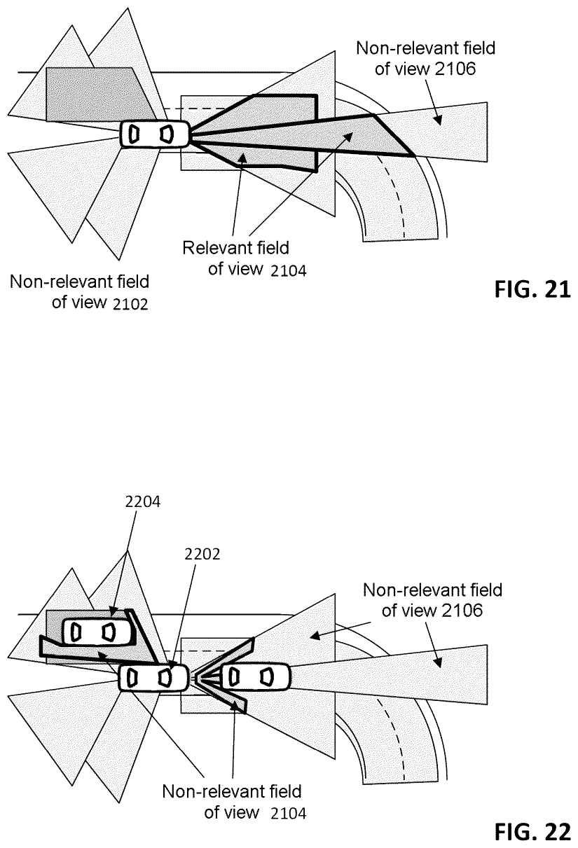

The SMS can then take into account the description of the sensors, e.g. FOV/modality. As a first step, the SMS can relate the information to the desired range of the components. This allows the SMS to determine the relevant part of the FOV for each sensor. This can be described, for example, by a polygon representing the intersection of the FOV of the sensor with the AoI. FIG. 21 shows this correlation between the FOV and the AoI. In this figure, for example, the FOV and the AoI overlap and are marked as relevant or irrelevant. In this figure, the region behind and to the right of the vehicle is defined as a non-relevant field of view 2102; at least a portion of a region in front of the vehicle is defined as a relevant field of view 2104 and the long-distance region in front of the vehicle is defined as a relevant field of view 2106 due to its limitation by an upcoming bend. For example, two different types of relevance can be considered in this and other figures. First, there may be a sensor field of relevance. In this way, a region may be irrelevant at least for a particular sensor if the sensor cannot provide any meaningful information in that region.

Secondly, regions may be relevant or irrelevant depending on the location of the hazard (e.g., danger zone). For example, in the case of the long-range sensor, the corresponding range of which is shown as 2106 and part of 2104, the danger zone may be limited by the road surface (for example, it is not necessarily expected that hazards will occur from outside the road surface). Alternatively, the danger zone can also be extended beyond the road surface (e.g. to allow for animals entering the roadway, pedestrians, etc.).

These relevant regions can be refined using information about the driving environment. This could be, for example, the bounding box information of the other vehicles in the area surrounding the vehicle. FIG. 22 shows the refinement of the information presented in FIG. 21 on the basis of the driving environment. For example, in FIG. 22 the non-relevant field of view 2102 has been eliminated and the vehicle driving ahead is shown in FIG. 22, which further restricts the non-relevant field of view 2106 by obscuring the long-range sensor. The primary vehicle (the sensor data of which is taken into account) is shown as 2202, the remaining vehicles are secondary vehicles. With respect to the secondary vehicle 2204, the areas of interest are delimited both by regions in which the perception of the sensor is blocked by an obstacle (e.g. by a secondary vehicle), and by the end of the road. As mentioned above, using the lane boundaries to delimit an area of interest is an optional configuration. In certain circumstances, it may be desirable to use the road surface to delimit the area of interest (e.g., when the areas of interest are exclusively within the road surface), while in other circumstances it may be desirable to consider some regions outside the road surface as an area of interest where possible (e.g. to allow for animals, obstacles, etc. entering the road from the far side of the road). The FOV can be determined in 3D, for example, in order to better distinguish whether it is possible to see above vehicles. In addition, the FOV should be determined on a sensor-specific basis. For example, radar can see under vehicles driving ahead due to reflections on the road surface, while LiDAR or a camera cannot do so.

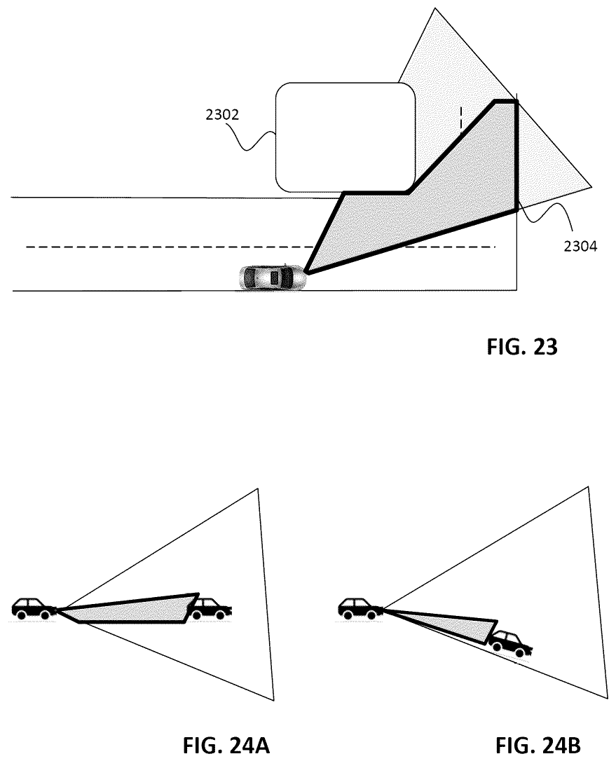

The current line of sight of the sensors or the static part of the environment, e.g. buildings, can also be used as a final restriction. FIG. 23 shows the inclusion of buildings in the line of sight calculation. Specifically, the vehicle is approaching an intersection where it wants to turn left. Near the left corner of the intersection there is a building 2302. This building 2302 obscures or limits part of the sensor FOV of the vehicle. For example, neither a camera nor a LiDAR sensor can see through or around the building. The bounding box 2304, which represents the field of view of the respective sensor, can be modified to reflect the concealment by the building (see e.g. the irregular polygon shape of the bounding box 2304, which represents the field of view of the camera). Note that 2304 indicates an area of interest bounded by the end of the road. As mentioned above, this is an optional configuration and it is possible alternatively to continue the area of interest beyond the edge of the road (for example, to allow for obstacles or other hazards entering the road from the far side of the road). In such an optional configuration, the area of interest would be delimited by the building 2302, but not by the edge of the road, as shown in FIG. 2304.

The current environment model can also be used to determine the vertical FOV. For this purpose, the bounding box information in 3D coordinates is required. The FOV is then determined by the height and the distance to the leading vehicle. FIG. 24A shows, for example, an FOV bounding box with a height attribute, wherein the bounding box shows a high and a low extreme, in which the sensor can detect a vehicle. In normal driving situations, this only plays a minor role, if at all; as in FIG. 24B, however, it may be necessary to take into account a vehicle driving ahead that reduces its height relative to the primary vehicle (e.g. if the vehicle in front is driving down a hill that the primary vehicle has not yet reached). This means that the system may in some circumstances need to check that the vehicle ahead is within the vertical field of view of the primary vehicle sensor. If there is no object in the field of view of the vehicle, the minimum vertical visual range cannot be determined. Therefore, a minimum size of the recognizable objects (MOS) can be used as a requirement. For example, a car with a height of 2 m at a distance of 50 m should be detected. With such a model assumption, the required field of view can be determined. Under certain circumstances, when considering the vertical aspect of the sensor data, it may be desirable to terminate the area of interest at ground level, as most sensors are unable to acquire information below ground level. Although an upper vertical limit may optionally be used for an area of interest, it may be desirable, for example for safety reasons, not to have an upper vertical limit for the area of interest. This means that it may be useful or important for the primary vehicle to take into account obstacles from regions that are higher than the primary vehicle (e.g. low bridges and the like).

The polygon of the desired FOV can then be forwarded to the sensor/SMS. This can then trigger an adjustment of the sensor, e.g. if no FOV is required the sensor can be switched off or put into standby mode. In addition or alternatively, the intensity (e.g. power) of the sensor can be reduced, e.g. to reduce a range of the FOV of the sensor. If the required distance is much less than the maximum range of the sensor, the intensity of the sensor can be adjusted, e.g. the LiDAR intensity or the radar energy can be adjusted. In addition or alternatively, the resolution or the sampling rate of the sensor can be reduced, e.g. to reduce the energy consumption of the sensor (e.g., the reduction of the resolution or the sampling rate is a compromise based on the assumption that the data generated by this sensor are at least temporarily of lesser importance for safe vehicle operation due to the evaluations of FOV, traffic conditions, intention and the like described above. Such adjustments can be made for the entire sensor or for individual regions of the sensor FOV.

As an alternative to changing the sensor settings, processing of the data generated by the sensor can be reduced or restricted. This can be achieved, for example, by eliminating distance measurements outside the requested range (e.g., the processing system does not perform these calculations based on the sensor data). This reduces the amount of information that must be exchanged and processed by the relevant components. For example, with a normal LiDAR mounted on the roof of the vehicle, it is not unusual for 20-30% of all measurements to be taken above the vehicle (e.g. in the sky) and 30-60% of all measurements to take place in the lanes to the left and right of the vehicle. If these are removed, the amount of data that needs to be processed, e.g. for object recognition, is significantly reduced, as is the latency and power consumption of these components. It should be noted that the measurement intensity can be a feature used in processing the data. Therefore, the sensor should normalize its output, taking into account the reduced intensity.

These changes can result in significant energy savings in connection with EVs. In general, radar is very efficient in terms of energy consumption, but not particularly reliable as a stand-alone sensor. One or more redundant sensor modalities (e.g. LiDAR, camera, etc.) may therefore be desirable or necessary for greater robustness. Future L3 systems may require multiple redundant modalities (e.g. radar, LiDAR, camera, etc.) to be incorporated, significantly increasing power consumption.

The following table shows an example of the estimated power requirements for various sensor and processing modalities. Since power consumption is closely related to the distance the electric vehicle can travel without recharging, even small power reductions over an extended period of time can significantly change the driving range of the vehicle.

| Technology | sensor | ECU |
|---|---|---|
| Lidar | 25 W | 30 W |
| Radar | negligible | 10-20 W |
| camera | 5 W | |
| Processing camera data | | 50 W |
| Driver assistance | | 33 W |
| Self-driving processing modules | | up to 750 W. |

As an example of a comparison of the sensor and computing power, it can be assumed that in a standard EV usage case, the EV requires about 15 KW per operating hour in a typical driving situation. The following table shows different configurations and their total power consumption using the example of a blind spot. As can be seen, when a robust (i.e. equipped with redundant sensors) blind spot system is used, 224 Watts of power are required for a 360 degree coverage. If this system is not in use and no other system uses the same sensors, 1.5% of the total power consumption of the vehicle can thus be saved by switching off the system and its sensors. Switching off the control units alone, assuming that the sensors are used elsewhere, results in a 0.7% saving. Taking into account additional ADAS/AD components such as turn assistant, parking assistance, highway pilot, etc., the overall savings could be about 1 to 5% of the total vehicle power consumption. These savings can increase further as the degree of autonomy increases, which requires more functions, more sensors, and more computing power, while the power consumption required for driving will remain essentially constant in future generations.

| Function | Sensors | Power | Total power |
|---|---|---|---|
| Blindspot - Basic | 4 Radar | 20-40 W | 40 W |
| Blind spot - redundancy | 4 Radar + | 40 W + | 59 W |
| | 3 cameras + | 9 W + | |
| | camera ECU | 10 W | |
| Complete - blind spot | 4 Radar + | 40 W | 224 |
| | 3 cameras + | 9 W | |
| | Camera ECU + | 10 W | |
| | 3 Lidar + | 75 | |
| | Lidar ECUs | 90 | |

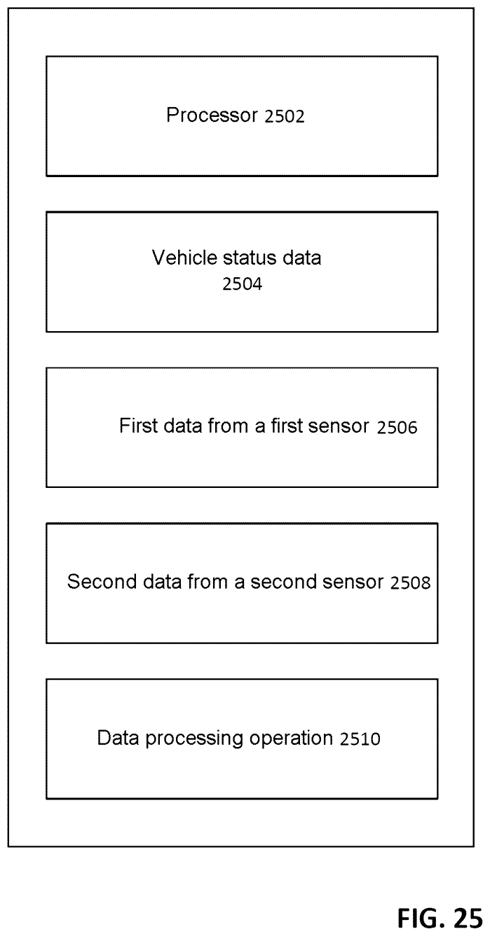

FIG. 25 shows a sensor data manager for a vehicle. The sensor data manager may include all or part of the functions of the CMS and/or SMS as disclosed herein. The sensor data manager is presented as being implemented in one processor, but it can also be implemented in a plurality of processors. The sensor data manager can be implemented in software.

The sensor data manager can comprise a processor 2505 (for example, if it is implemented as a device, as opposed to software or a procedure). The processor is configured to receive vehicle status data 2504 or first data from a first sensor 2506. The processor is further configured to generate, on the basis of the first data, an instruction to change a setting of a second sensor 2508 or to change a data processing procedure 2510 for second data from the second sensor.

The first sensor may be any sensor of the vehicle and may explicitly include one or more cameras, one or more LiDAR sensors, one or more radar sensors or the like. The second sensor may be a sensor for use in a driving assistance operation, or the data processing procedure may be a data processing procedure for an automated driving function operation. This can also be any sensor, explicitly including one or more cameras, one or more LiDAR sensors, one or more radar sensors or similar. A change in the second sensor setting or a change in the manner in which the second sensor data is processed can enable optimized power consumption in electric vehicles by managing the operating states of the vehicle sensors and the associated data processing procedures. After receiving the first data, the processor can evaluate this information to determine the operational necessity of a second sensor or the data processing procedure thereof. Based on the above evaluation, the processor can, for example, generate an instruction to completely turn off the second sensor, which is used for driving assistance functions such as lane-maintenance assistance, to put it in standby mode or to reduce its sensitivity or data processing frequency or resolution. Alternatively, the instruction may be to change the way in which the data of the second sensor are processed.

As mentioned above, the second sensor may be any sensor involved in driving assistance functions, such as radar, LiDAR or cameras, and changing its setting may include adjustments to its operating state, the power consumption, the data transfer rate, the resolution, the sampling rate, or other parameters. Similarly, the modification of the data processing procedure could involve the modification of parameters such as the complexity of the data analysis algorithms, the data processing rate, or the parts of the data to be processed (e.g., by processing less than all of the data or feeding it to the processor for processing, because the data are outside an area of interest).

This takes advantage of the interaction between the vehicle sensors and their data processing requirements, allowing the data and associated sensors to be optimized in real time based on their respective requirements, thereby improving the energy efficiency of the electric vehicle while maintaining appropriate safety and performance.

The vehicle status data can be status data relating to a sensor or a component of the vehicle or its environment. The vehicle status data may include, for example, data indicating which modules are in operation (e.g., whether a lane assistant is in operation, whether a highway assistant is in operation, etc.), data indicating the available computing resources, data indicating the available battery resources, or similar. Although the vehicle status data can be received from the vehicle or its sensor, the vehicle status data can also be received in an optional device of another vehicle (e.g. another vehicle near the vehicle), an infrastructure element or another source outside the vehicle. In this configuration, the vehicle would also need a receiver or a transceiver to allow the vehicle to receive signals from external sources.

In an optional configuration, generating the instruction to change the setting of the second sensor comprises generating an instruction to change a power, a resolution or a sampling frequency of the second sensor or causes the second sensor to enter an off state or a standby state.

In an optional configuration, the process of generating an instruction to change the setting of a second sensor may include various specific modifications, such as changing the energy consumption, the resolution, or the sampling frequency of the second sensor. In addition, the command can instruct the second sensor to switch to an off state or standby mode to effectively reduce its power consumption when less critical operations are detected or when the vehicle is in a state that does not require high sensor functionality.

The processor can apply predefined criteria when evaluating the first data received from the first sensor in order to determine the necessary adjustments to the functions of the second sensor. For example, the processor can reduce the resolution or the sampling frequency of a LiDAR or camera system used for driving assistance. Such a reduction in the resolution or the sampling frequency under less demanding conditions will save energy with acceptable changes to the essential functions of the sensor.

Alternatively, or in addition, if certain sensor functions are deemed unnecessary, the processor may instruct the second sensor to switch to a standby mode or switch itself off completely. This ability to dynamically change the sensor operation based on real-time data analysis optimizes energy usage. Through this adaptive management approach, the sensor data manager ensures that the second sensor only operates at the level of activity required to support the current driving conditions, thereby maximizing energy efficiency and contributing to more sustainable and economical operation of electric vehicles.

In another optional configuration, the sensor data manager can generate an instruction to change the data processing procedure by either performing a driving assistance operation without processing the second data or selectively processing only parts of the second data. This tailor-made approach to the data processing enables energy savings by reducing the computing load on the vehicle processing unit, for example in situations where full data processing is not required or would otherwise not produce relevant results; for example, when processing data corresponding to a region outside the area of interest.

For example, in a scenario in which full environmental and object recognition is not required, the processor could instruct the system to ignore some sensor data (e.g., camera data, LiDAR data, radar data, etc.). Alternatively or in addition, the processor could disable certain algorithmic operations, such as machine learning procedures, which are energy-intensive and under certain driving conditions may not be required.

In another optional configuration of the sensor data manager, generating an instruction to change the data processing procedure may include the formulation of an instruction that causes a driving assistance circuit to reduce the weighting of the second data in its operating algorithms. This change in the data weighting enables a more energy-efficient processing approach by prioritizing or deprioritizing the impact of the second data based on real-time assessments of the driving conditions and vehicle status. By adjusting the weighting of the second data, the system can significantly reduce the computational energy required to process these data, for example in complex algorithms that involve multiple data sources.

This approach not only saves energy, but also preserves the adaptive and responsive nature of the vehicle driver assistance functions. By dynamically adjusting the data processing priorities, this embodiment improves the efficiency of the energy consumption of the vehicle without reducing safety or performance, which is consistent with the objective of various aspects of this disclosure to optimize the energy consumption of electric vehicles through intelligent sensor management.

In another optional sensor data manager configuration, the processor can consider the location of the vehicle represented by the first data in order to determine the appropriate settings for the second sensor or the associated data processing procedures. This site-based decision-making enables the vehicle to adapt its sensor and data processing operations to specific environmental or geographical requirements, thereby improving energy efficiency through context relevance.

This allows the processor to receive GPS data or other location-determining signals that provide real-time information about the current geographical position of the vehicle. Based on this location data, the processor can retrieve map information about the environment of the vehicle and/or evaluate environmental variables such as urban or rural environments, road types, traffic conditions, and regulatory requirements that may vary from one location to another.

In addition, when entering areas with known environmental factors such as steep gradients, sharp bends, or areas with adverse weather conditions, the location data can trigger specific adjustments to the sensor operation in which different sensor settings may be beneficial for optimal vehicle operation and safety. For example, geolocation data can be used to allow the system to retrieve a map of the road and determine whether and if so, which intersections or turns are located nearby. As described above, the relevance of the second data may be impaired if the second data relate to an area where the vehicle does not intend to stop (e.g. the vehicle intends to turn off at the next intersection, but the second data refer to an area straight ahead and behind the intersection).

In another optional sensor data manager configuration, the processor can also use the first data to indicate when the vehicle is inside an enclosed space, such as a garage or covered parking lot. In this scenario, the second data, originating from a location sensor such as a GPS or other navigation aids, are subject to a selective operation control by the processor based on the enclosed state of the vehicle. This can also take place if the first sensor data indicate that the vehicle is in a position associated with poor signal strength of a position sensor. That is, certain areas (e.g., parking garages, tunnels, and even areas between buildings) may be associated with a GPS signal strength that is outside a specified range. If the vehicle is in such an area (e.g. based on the data from the first sensor), the second sensor can be switched off.

The processor is configured to detect if the first data indicate that the vehicle is in a closed space-a state in which location sensors are usually less effective or unnecessary. If this state is detected, the processor can be programmed to either turn off the position sensor completely or adjust the data processing procedure such that the second data from that sensor are temporarily disregarded.

For example, if the vehicle enters an underground parking garage and the first sensor (e.g. an environment sensor that detects a closed space) registers this environment, the processor automatically sends an instruction to disable the GPS sensor or to exclude GPS data from the driving assistance operation. This minimizes the use of the power-consuming search mode of the sensor, which would otherwise continue to attempt to locate a signal in an environment where the GPS connection is inherently compromised.

In another optional implementation of the sensor data manager, the processor may be configured to use first data to determine the absence of the vehicle from a highway. This implementation focuses on saving energy by disabling certain features that are not required when the vehicle is not driving on a highway. For example, the processor is configured to detect when the first data indicate that the vehicle is not traveling on a highway and then to issue an instruction to turn off the highway pilot driver assistance operation.

Highway pilot driving assistance is usually designed to perform tasks such as lane maintenance, adaptive cruise control and speed adjustment, which are specifically tailored to the driving conditions on highways. If the first data-derived from sensors that can detect the road type, such as GPS systems or cameras for traffic sign recognition-confirm that the vehicle is traveling on urban or rural roads and not on highways, the processor can automatically disable the highway-specific functions. This decision may be based on the consideration that the high-precision and high-performance functions of the highway pilot are not necessary under non-highway conditions where driving behavior is more variable and less predictable.

By disabling these advanced driver assistance systems when the vehicle is not on a highway, the system can reduce unnecessary power consumption and computational effort for vehicle systems.

In another optional sensor data manager configuration, the system may include the use of time data (in this case a portion of the first data) to manage the settings of a second sensor in an energy-efficient manner. This implementation uses time-based data to dynamically adjust the operating state of the second sensor so as to optimize power consumption during daily operation of the vehicle.

The processor in this optional configuration is specifically configured to receive and interpret time information that is a critical factor in determining the functional requirements of the second sensor. For example, during times of low traffic volumes, such as late evening or early morning, the processor can reduce the sensitivity or sampling rate of traffic-related sensors such as radars or optical cameras, which are typically more active during peak traffic hours. Conversely, the processor ensures that these sensors are fully operational during daytime or rush hours to ensure optimum safety and performance. This may go beyond traffic patterns and include the likelihood of the presence of livestock or other animals or other objects or items which, if located on or near the road, may pose an increased risk to the vehicle.

In addition, the processor can use the time data to anticipate and adjust time-dependent driving conditions. For example, at dusk, the settings of the photosensitive sensors can be adjusted to better respond to reduced visibility, thus saving energy at times when the full performance of the sensors is less important.

In another optional configuration, the system may include a more differentiated treatment of sensor data based on spatial relevance, thereby improving the energy efficiency of the sensor management of an electric vehicle. In this configuration, a dual determination method can be used, which includes the area of relevance for the driving operation and the area of relevance for the second data, whereby the vehicle processor can manage the sensor settings or data processing procedures intelligently and efficiently.

To do this, the processor can first evaluate an area of relevance for the driving operation, which might be defined by parameters such as the current and expected route of the vehicle, nearby vehicle and pedestrian traffic, and environmental conditions such as construction sites or weather-related obstacles. At the same time, the processor can evaluate an area of relevance of the second data.

The processor then analyzes whether there is an overlap between these two areas of relevance. If the overlap is outside a specified range (an overlap within the specified range indicates a relevance or usefulness of the information from the second sensor), which means that the data from the second sensor are irrelevant or less relevant to the current driving requirements, the processor can generate an instruction to change the settings of the second sensor. This instruction could include adjusting the sensitivity, range, or operating mode of the sensor, or changing the way in which the sensor data is processed, such as reducing the processing of unimportant data to save energy.

For example, if the vehicle is driving through a densely populated urban area, but the second data from a long-range radar designed for driving on the highway is not relevant to the immediate driving conditions in the city, the processor could reduce the range of the radar or turn it off altogether. On the other hand, if the vehicle is approaching a highway and the area in which the second data are relevant is crucial for safe driving at high speed, the processor would ensure that the radar is fully functional.

In another optional configuration, the sensor data manager may comprise a method for managing the settings of a second sensor or its data processing procedures, which is oriented to the spatial relevance for the current driving operation. In this configuration an area is determined that is relevant both to the driving operation and to the data generated by the second sensor, resulting in optimized sensor functionality and improved energy efficiency. The processor may be configured to analyze the area relevant to the driving operation based on factors such as the current vehicle location, the planned route, the traffic conditions, and expected environmental interactions. At the same time, the processor can evaluate the area of relevance of the second data, which can be supplied, for example, by sensors such as LiDAR, radar or cameras that have specific ranges and capabilities.

In an optional configuration, the sensors may be located outside the vehicle, for example as part of a road-side device. In this way, the sensor located outside the vehicle can acquire sensor data, and these sensor data can then be sent to the vehicle using a wireless communication method. In an optional configuration, the sensor data can be sent from the external sensor to the vehicle via a Vehicle-to-Everything (V2X) communication protocol. Further aspects of the disclosure are described using examples:

In Example 1, a sensor data manager for a vehicle contains: a processor configured to: receive vehicle status data or first data from a first sensor; generate an instruction to change a setting of a second sensor or to change a data processing procedure for second data from the second sensor, based on the first data; wherein the second sensor is a sensor for use in a driving assistance operation; or wherein the data processing procedure is a data processing procedure for an automated driving function operation.

Example 2: The sensor data manager according to Example 1, wherein generating the instruction to change the setting of the second sensor comprises generating an instruction to change a power, a resolution or a sampling frequency of the second sensor or to cause the second sensor to enter an off state or a standby state.

Example 3: The sensor data manager according to Example 1 or 2, wherein generating the instruction to change the data processing procedure comprises generating an instruction to cause an automated driving operation to proceed without processing the second data. (or to process only parts of the data)

Example 4: The sensor data manager according to Example 1 or 2, wherein generating the instruction to change the data processing procedure comprises generating an instruction to cause a driving assistance circuit to reduce the weight given to the second data.

Example 5: The sensor data manager according to one of Examples 1 to 4: wherein the first data represent a location of the vehicle; and wherein the processor is configured to generate the instruction to change the setting of the second sensor or to change the data processing procedure for second data based on the location of the vehicle.

Example 6: The sensor data manager according to Example 5: wherein the first data indicate that the vehicle is in an enclosure; wherein the second data are data of a positioning sensor; and wherein the processor is configured to instruct to turn off the positioning sensor or instruct the data processing procedure not to take into account the second data during a period in which the first data indicate that the vehicle is in the enclosure.

Example 7: The sensor data manager according to Example 6, wherein the enclosure is a tunnel or a parking garage.

Example 8: The sensor data manager according to Example 5, wherein the first data indicate that the vehicle is not on a highway, and wherein the processor is configured so that it instructs to turn off a highway pilot driver assistance operation during a period in which the first data indicate that the vehicle is not on the highway.

Example 9: The sensor data manager according to one of the Examples 1 to 8: wherein the first data represent a time; and wherein the processor is configured to instruct to change the setting of the second sensor based on the time.

Example 10: The sensor data manager according to Example 9, wherein the time corresponds to a period of night-time darkness and the second sensor is a sensor that requires light for operation.

Example 11: The sensor data manager according to Example 9: wherein the first data represent a time; and wherein the processor is configured to instruct to change the data processing procedure for the driver assistance operation based on the time.

Example 12: The sensor data manager according to one of the Examples 1 to 11, wherein generating the instruction to change the setting of the second sensor or to change the data processing procedure based on the first data comprises the following: determining an area of relevance for a driving operation; determining an area of relevance of the second data;

generating the instruction to change the setting of the second sensor or to change the data processing procedure, if an overlap between the area of relevance for the driving operation and the area of relevance for the second data is outside of a predetermined range.

Example 13: The sensor data manager according to Example 12, wherein the processor is further configured not to generate the instruction to change the setting of the second sensor or the instruction to change the data processing procedure, if the overlap between the area of relevance for the driving operation and the area of relevance for the second data is within the specified range.

Example 14: The sensor data manager according to Example 12, wherein the processor is configured to determine the area of relevance of the second data by considering an arbitrary location of the vehicle on a multi-lane street, a current time, whether the field of view of a sensor is obstructed, the presence of a nearby object or obstacle, or a planned driving task.

Example 15: The sensor data manager according to Example 12, wherein the processor is configured so as to determine the area of relevance for the second data by means of an operating range of the second sensor and a time of day.

Example 16: The sensor data manager according to Example 12, wherein the processor, which is configured to determine the area of relevance for the driving operation when the vehicle is driving in the furthest left lane, includes the processor which is configured to exclude from the area of relevance an area on a left side of the vehicle, or wherein the processor, which is configured to determine the area of relevance for driving operation when the vehicle is driving in the furthest right lane, includes the processor which is configured to exclude from the area of relevance an area on a right-hand side of the vehicle.

Example 17: The sensor data manager according to Example 12, wherein the processor, which is configured to determine the area of relevance for the driving operation when an object obstructs a long-range view from the vehicle, includes the processor which is configured to exclude from the area of relevance an area that is obstructed by the object.

Example 18: The sensor data manager according to Example 12, wherein, when the vehicle is driving on a winding road, the processor, which is configured to determine the area of relevance for the driving operation, includes the processor which is configured to exclude from the area of relevance an area in front of the vehicle, which is different from a road on which the vehicle is driving or is likely to be driving.

Example 19: The sensor data manager according to Example 12, wherein the processor, which is configured to determine the area of relevance for the driving operation when the probability of a lane change is low, includes the processor which is configured to exclude from the area of relevance an area in a lane different than the lane in which the vehicle is traveling.

Example 20: The sensor data manager according to one of the examples 1 to 19, further comprising third data representing an intended action of the vehicle; wherein the processor is configured to determine the area of relevance for the driving operation by excluding from the area of relevance an area that does not correspond to a predicted future location of the vehicle based on the intended action.

Example 21: The sensor data manager according to one of the examples 1 to 20, wherein the instruction is a first instruction and wherein the processor is further configured to: determine a buffer duration on the basis of a speed of the vehicle; to determine from the first data a time at which the relevance of the second data to the vehicle increases; and to generate a second instruction during the buffer duration prior to the time, wherein the second instruction is an instruction to change the setting of the second sensor or to change the data processing procedure for the second data.

Example 22: The sensor data manager according to Example 21, wherein the processor is configured to determine the buffer duration based on the speed of the vehicle and a reaction time.

Example 23: The sensor data manager according to Example 21 or 22, wherein the second command is a command to restore a setting of the second sensor or of the data processing procedure to a state prior to the first command.

Example 24 is a sensor data manager for a vehicle, comprising: a processor for: receiving vehicle status data or first data from a first sensor; generating an instruction to change a setting of a second sensor or to change a data processing procedure for second data from the second sensor, based on the first data; wherein the second sensor is a sensor for use in a driving assistance operation; or wherein the data processing procedure is a data processing procedure for an automated driving function operation.

Example 25: The sensor data manager according to Example 24, wherein generating the instruction to change the setting of the second sensor comprises generating an instruction to change a power, a resolution or a sampling frequency of the second sensor or to cause the second sensor to enter an off state or a standby state.

Example 26: The sensor data manager according to Example 24 or 25, wherein generating the instruction to change the data processing procedure comprises generating an instruction to cause an automated driving operation to proceed without processing the second data. (or to process only parts of the data)

Example 27: The sensor data manager according to Example 24 or 25, wherein generating the instruction to change the data processing procedure comprises generating an instruction to cause a driving assistance circuit to reduce the weight given to the second data.

Example 28: The sensor data manager according to one of Examples 24 to 27: wherein the first data represent a location of the vehicle; and wherein the processor is configured to generate the instruction to change the setting of the second sensor or to change the data processing procedure for second data based on the location of the vehicle.

Example 29: The sensor data manager according to Example 28: wherein the first data indicate that the vehicle is in an enclosure; wherein the second data are data of a positioning sensor; and wherein the processor further serves to turn off the positioning sensor or to instruct the data processing procedure not to take into account the second data during a period in which the first data indicate that the vehicle is in the enclosure.

Example 30: The sensor data manager according to Example 29, wherein the enclosure is a tunnel or a parking garage.

Example 31: The sensor data manager according to Example 28, wherein the first data indicate that the vehicle is not on a highway, and wherein the processor further serves to instruct a highway pilot driver assistance operation to be turned off during a period in which the first data indicate that the vehicle is not on the highway.

Example 32: The sensor data manager according to one of the examples 24 to 31: wherein the first data represent a time; and wherein the processor further serves to change the setting of the second sensor based on the time.

Example 33: The sensor data manager according to Example 32, wherein the time corresponds to a period of night-time darkness and the second sensor is a sensor that requires light for operation.

Example 34: The sensor data manager according to Example 32: wherein the first data represent a time; and wherein the processor further serves to change the data processing procedure for the driver assistance operation based on the time.

Example 35: The sensor data manager according to one of the Examples 24 to 34, wherein generating the instruction to change the setting of the second sensor or to change the data processing procedure based on the first data comprises the following: determining an area of relevance for a driving operation; determining an area of relevance of the second data; generating the instruction to change the setting of the second sensor or to change the data processing procedure, if an overlap between the area of relevance for the driving operation and the area of relevance for the second data is outside of a predetermined range.

Example 36: The sensor data manager according to Example 35, wherein the processor further serves not to generate the instruction to change the setting of the second sensor or the instruction to change the data processing procedure, if the overlap between the area of relevance for the driving operation and the area of relevance for the second data is within the specified range.

Example 37: The sensor data manager according to Example 35, wherein the processor is configured to determine the area of relevance of the second data by considering the location of the vehicle on a multi-lane street, the current time, whether the field of view of a sensor is obstructed, the presence of a nearby object or obstacle, or a planned driving task.

Example 38: The sensor data manager according to Example 35, wherein the processor is configured so as to determine the area of relevance for the second data by means of an operating range of the second sensor and a time of day.

Example 39: The sensor data manager according to Example 35, wherein, when the vehicle is driving in the furthest left lane, in order to determine the area of relevance for the driving operation, the processor includes the processor that is configured to exclude an area on the left side of the vehicle from the area of relevance, or wherein, when the vehicle is driving in the furthest right lane, in order to determine the area of relevance for the driving operation, the processor includes the processor that is configured to exclude an area on the right side of the vehicle from the area of relevance.

Example 40: The sensor data manager according to Example 35, wherein, when an object obstructs the long-range view from the vehicle, in order to determine the area of relevance for the driving operation, the processor is configured to exclude from the area of relevance an area obstructed by the object.

Example 41: The sensor data manager according to Example 35, wherein, when the vehicle is driving on a winding road, in order to determine the area of relevance for the driving operation, the processor is configured to exclude from the area of relevance an area in front of the vehicle, which is different from a road on which the vehicle is driving or is likely to be driving.

Example 42: The sensor data manager according to Example 35, wherein, when the probability of a lane change is low, in order to determine the area of relevance for the driving operation, the processor includes the processor which is used to exclude from the area an area in a different lane than the lane in which the vehicle is driving.

Example 43: The sensor data manager according to one of the examples 24 to 42, further containing third data representing an intended action of the vehicle; wherein the processor is used to determine the area of relevance for the driving operation by excluding from the area of relevance an area that does not correspond to a predicted future location of the vehicle based on the intended action.

Example 44: The sensor data manager according to one of the examples 24 to 43, wherein the instruction is a first instruction and wherein the processor is further used to: determine a buffer duration on the basis of a speed of the vehicle; to determine from the first data a time at which the relevance of the second data to the vehicle will increase; and to generate a second instruction during the buffer duration prior to the time, wherein the second instruction is an instruction to change the setting of the second sensor or to change the data processing procedure for the second data.

Example 45: The sensor data manager according to Example 44, wherein the processor is used to determine the buffer duration based on the speed of the vehicle and a reaction time.

Example 46: The sensor data manager according to Example 44 or 45, wherein the second command is a command to restore a setting of the second sensor or of the data processing procedure to a state prior to the first command.

In Example 47, a non-transient computer-readable medium contains instructions which, when executed, cause a processor to receive vehicle status data or first data from a first sensor; to generate an instruction to change a setting of a second sensor or to change a data processing procedure for second data from the second sensor, based on the first data; wherein the second sensor is a sensor for use in a driving assistance operation; or wherein the data processing procedure is a data processing procedure for an automated driving function operation.

Example 48: The non-transient computer-readable medium according to Example 47, wherein generating the instruction to change the setting of the second sensor comprises generating an instruction to change a power, a resolution or a sampling frequency of the second sensor or to cause the second sensor to enter an off state or a standby state.

Example 49: The non-transient computer-readable medium according to Example 47 or 48, wherein generating the instruction to change the data processing procedure comprises generating an instruction to cause an automated driving process to proceed without processing the second data. (or to process only parts of the data)

Example 50: The non-transient computer-readable medium according to Example 47 or 48, wherein generating the instruction to change the data processing procedure comprises generating an instruction which causes a driving assistance circuit to reduce a weight given to the second data.

Example 51: The non-transient computer-readable medium according to one of Examples 47 to 50: wherein the first data represent a location of the vehicle; and wherein the instruction are further configured to cause the processor to generate the instruction to change the setting of the second sensor or to change the data processing procedure for second data based on the location of the vehicle.

Example 52: The non-transient computer-readable medium according to Example 51: wherein the first data indicate that the vehicle is in an enclosure; wherein the second data are data of a positioning sensor; and wherein the instructions are further configured to instruct the processor to turn off the positioning sensor or to instruct the data processing procedure not to take into account the second data during a period in which the first data indicate that the vehicle is in the enclosure.

Example 53: The non-transient computer-readable medium according to Example 52, wherein the enclosure is a tunnel or a parking garage.

Example 54: The non-transient computer-readable medium according to Example 51, wherein the first data indicate that the vehicle is not on a highway, and wherein the instructions are further configured to cause the processor to instruct a highway pilot driver assistance operation to be turned off during a period in which the first data indicate that the vehicle is not on the highway.

Example 55: The non-transient computer-readable medium according to one of Examples 47 to 54: wherein the first data represent a time; and wherein the instructions are further configured to cause the processor to change the setting of the second sensor based on the time.

Example 56: The non-transient computer-readable medium of Example 55, wherein the time corresponds to a period of night-time darkness, and wherein the second sensor is a sensor that requires light for operation.

Example 57: The non-transient computer-readable medium according to Example 55: wherein the first data represent a time; and wherein the instructions are further configured to cause the processor to instruct the change of the data processing procedure for the driving assistance process based on the time.

Example 58: The non-transient computer-readable medium according to one of Examples 47 to 57, wherein generating the instruction to change the setting of the second sensor or to change the data processing procedure based on the first data comprises the following: determining an area of relevance for a driving operation; determining an area of relevance of the second data and generating the instruction to change the setting of the second sensor or to change the data processing procedure, if an overlap between the area of relevance for the driving operation and the area of relevance for the second data is outside of a predetermined range.

Example 59: The non-transient computer-readable medium according to Example 58, wherein the instructions are configured so as to cause the processor not to generate the instruction to change the setting of the second sensor or the instruction to change the data processing procedure, if the overlap between the area of relevance for the driving operation and the area of relevance for the second data is within the specified range.

Example 60: The non-transient computer-readable medium according to Example 58, wherein the instructions are configured to cause the processor to determine the area of relevance of the second data by considering a location of the vehicle on a multi-lane street, a current time, whether the field of view of a sensor is obstructed, the presence of a nearby object or obstacle, or a planned driving task.

Example 61: The non-transient computer-readable medium according to Example 58, wherein the instructions are further configured such that they cause the processor to determine the area of relevance for the second data by means of an operating range of the second sensor and a time of day.

Example 62: The non-transient computer-readable medium according to Example 58, wherein, when the vehicle is driving in the furthest left lane, the instructions are further configured to cause the processor to determine the area of relevance for the driving operation, including the processor which is configured such that it excludes an area on the left-hand side of the vehicle from the area of relevance, or wherein, if the vehicle is driving in a right-hand lane, the instructions are further configured in such a way that the processor is caused to determine the area of relevance for the driving operation, including the processor which is configured to exclude from the area of relevance an area on the right-hand side of the vehicle.

Example 63: The non-transient computer-readable medium according to Example 58, wherein, when an object obstructs a long-range view from the vehicle, the instructions are further configured to cause the processor to determine the area of relevance for the driving operation, wherein the processor is configured in such a way that it excludes from the area of relevance an area obstructed by the object.

Example 64: The non-transient computer-readable medium according to Example 58, wherein, when the vehicle is driving on a winding road, the instructions are further configured to cause the processor to determine the area of relevance for the driving operation, including the processor which is configured such that it excludes from the area an area in front of the vehicle that is different than a road on which the vehicle is driving or likely to be driving.

Example 65: The non-transient computer-readable medium according to Example 58, wherein, if the probability of a lane change is low, the instructions that are configured to cause the processor to determine the area of relevance for the driving operation include the instructions that are configured to cause the processor to exclude from the area of relevance an area in a different lane than the lane in which the vehicle is driving.

Example 66: The non-transient computer-readable medium according to one of the examples 47 to 65, further comprises third data representing an intended action of the vehicle; wherein the instructions are further configured to cause the processor to determine the area of relevance for the driving operation by excluding from the area of relevance an area that does not correspond to a predicted future location of the vehicle based on the intended action.

Example 67: The non-transient computer-readable medium according to one of the examples 47 to 66, wherein the instruction is a first instruction and wherein the instructions are further configured to: determine a buffer duration on the basis of a speed of the vehicle; to determine from the first data a time at which the relevance of the second data to the vehicle increases; and to generate a second instruction during the buffer duration prior to the time, wherein the second instruction is an instruction to change the setting of the second sensor or to change the data processing procedure for the second data.

Example 68: The non-transient computer-readable medium according to Example 67, wherein the instructions are further configured to cause the processor to determine the buffer duration based on the speed of the vehicle and a reaction time.

Example 69: The non-transient computer-readable medium according to Example 67 or 68, wherein the second command is a command to reset a setting of the second sensor or the data processing procedure to a state prior to the first command.

In Example 70 a method for a vehicle comprises: receiving vehicle status data or first data from a first sensor; generating an instruction to change a setting of a second sensor or to change a data processing procedure for second data from the second sensor, based on the first data; wherein the second sensor is a sensor for use in a driving assistance operation; or wherein the data processing procedure is a data processing procedure for an automated driving function operation.

Example 71: The method according to Example 70, wherein generating the instruction to change the setting of the second sensor comprises generating an instruction to change a power, a resolution or a sampling frequency of the second sensor or to cause the second sensor to enter an off state or a standby state.

Example 72: The method according to Example 70 or 71, wherein generating the instruction to change the data processing procedure comprises generating an instruction to cause an automated driving operation to proceed without processing the second data. (or to process only parts of the data)

Example 73: The method according to Example 70 or 71, wherein generating the instruction to change the data processing procedure comprises generating an instruction which causes a driving assistance circuit to reduce a weight given to the second data.

Example 74: The method according to one of examples 70 to 73: wherein the first data represent a location of the vehicle; and further, generating the instruction to change the setting of the second sensor or to change the data processing procedure for second data based on the location of the vehicle.

Example 75: The method according to Example 74: wherein the first data indicate that the vehicle is in an enclosure; wherein the second data are data of a positioning sensor; and further including the instruction to turn off the positioning sensor or to instruct the data processing procedure not to take into account the second data during a period in which the first data indicate that the vehicle is in the enclosure.

Example 76: The method according to example 75, wherein the enclosure is a tunnel or a parking garage.

Example 77: The method according to Example 74, in which the first data indicate that the vehicle is not on a highway, and which further comprises the instruction to turn off a highway pilot driver assistance operation during a period in which the first data indicate that the vehicle is not on the highway.

Example 78: The method according to one of examples 70 to 77: wherein the first data represent a time; and also the instruction to change the setting of the second sensor based on the time.

Example 79: The method according to Example 78, wherein the time corresponds to a period of night-time darkness and the second sensor is a sensor that requires light for operation.

Example 80: The method according to Example 78, wherein the first data represent a time; and further including the instruction to change the data processing procedure for the driving assistance operation on the basis of the time.

Example 81: The method according to one of Examples 70 to 80, wherein generating the instruction to change the setting of the second sensor or to change the data processing procedure based on the first data comprises the following: determining an area of relevance for a driving operation; determining an area of relevance of the second data; generating the instruction to change the setting of the second sensor or to change the data processing procedure, if an overlap between the area of relevance for the driving operation and the area of relevance for the second data is outside of a predetermined range.

Example 82: The method according to Example 81, further comprising not to generate the instruction to change the setting of the second sensor or not to generate the instruction to change the data processing procedure, if the overlap between the area of relevance for the driving operation and the area of relevance for the second data is within the specified range.

Example 83: The method according to Example 81, wherein the area of relevance of the second data is determined by considering the location of the vehicle on a multi-lane street, the current time, whether the field of view of a sensor is obstructed, the presence of a nearby object or obstacle, or a planned driving task.

Example 84: The method according to Example 81, further comprising determining the area which is relevant for the second data by means of an operating range of the second sensor and a time of day.

Example 85: The method according to Example 81, further comprising that, when the vehicle is driving in the furthest left lane, the processor is configured such that it determines the area of relevance for the driving operation by excluding an area on the left-hand side of the vehicle from the area of relevance, or wherein, if the vehicle is driving in the furthest right lane, determining the area of relevance for the driving includes the processor being configured to exclude from the area of relevance an area on the right-hand side of the vehicle.

Example 86: Method according to Example 81, in which, if an object obstructs a long-range view from the vehicle, determining the area of relevance for the driving operation comprises the exclusion from the area of relevance of an area that is obstructed by the object.

Example 87: The method according to Example 81, wherein, if the vehicle is driving on a winding road, the determination of the area of relevance for the driving operation is configured such that the processor is configured to exclude from the area of relevance an area in front of the vehicle, which is different from a road on which the vehicle is driving or likely to be driving.

Example 88: Method according to Example 81, further comprising, if the probability of a lane change is low, determining the area of relevance for the driving operation by excluding from the area of relevance an area in a different lane than that in which the vehicle is driving.

Example 89: The method according to one of Examples 70 to 88, further comprising third data representing an intended action of the vehicle; wherein the area of relevance for the driving operation is determined by excluding from the area of relevance an area which does not correspond to a predicted future position of the vehicle on the basis of the intended action.

Example 90: Method according to one of examples 70 to 89, wherein the instruction is a first instruction, and further comprises: determining a buffer duration based on the speed of the vehicle; determining from the first data a time at which the relevance of the second data to the vehicle will increase; and generating a second instruction during the buffer duration prior to the time, wherein the second instruction is an instruction to change the setting of the second sensor or to change the data processing procedure for the second data.

Example 91: Method according to Example 90, further comprising determining the buffer duration on the basis of the speed of the vehicle and a reaction time.

Example 92: The method according to Example 90 or 91, wherein the second command is a command to reset a setting of the second sensor or the data processing procedure to a state prior to the first command.

It is assumed that the implementations of the methods described herein are demonstrative in character and can therefore be implemented in an appropriate device. It is also assumed that implementations of the devices described herein can be implemented as a corresponding method. It therefore goes without saying that a device that corresponds to a method described herein may contain one or more components configured to carry out every aspect of the corresponding method.

All acronyms defined in the above description also apply to all claims contained herein.

1. A sensor data manager for a vehicle comprising:
a processor, configured to:
receive vehicle status data or first data from a first sensor;
generate an instruction to change a setting of a second sensor or to change a data processing procedure for second data from the second sensor, based on the vehicle status data or the first data;
wherein the second sensor is a sensor for use in an automated driving function; or wherein the data processing procedure is a data processing procedure for an automated driving function.

2. The sensor data manager of claim 1,
wherein generating the instruction to change the setting of the second sensor comprises generating an instruction to change a power, a resolution, a field-of-view region, a range or a sampling frequency of the second sensor, or to cause the second sensor to enter an off mode or a standby mode.

3. The sensor data manager of claim 1,
wherein generating the instruction to change the data processing procedure comprises generating an instruction to use an automated driving function without processing the second data.

4. The sensor data manager of claim 1, wherein generating the instruction to change the data processing procedure comprises generating an instruction to cause an automated driving function to reduce the weight given to the second data.

5. The sensor data manager as of claim 1,
wherein the first data represent a location and/or an alignment/orientation of the vehicle; and
wherein the processor is configured to generate the instruction to change the setting of the second sensor or to change the data processing procedure for second data based on the location or an alignment/orientation of the vehicle.

6. The sensor data manager of claim 1,
wherein generating the instruction to change the setting of the second sensor or to change the data processing procedure based on the first data comprises:
determining an area of relevance for a driving operation;
determining an area of relevance of the second data;
generating the instruction to change the setting of the second sensor or to change the data processing procedure, if an overlap between the area of relevance for the driving operation and the area of relevance for the second data is outside of a predetermined range.

7. The sensor data manager as claimed in claim 6,
wherein the processor is further configured not to generate the instruction to change the setting of the second sensor or not to generate the instruction to change the data processing procedure, if the overlap between the area of relevance for the driving operation and the area of relevance for the second data is within the predetermined range.

8. The sensor data manager as claimed in claim 7,
wherein the first data indicate that the vehicle is at a location that is associated with a signal strength of a position sensor being outside of a predetermined range;
wherein the second data are data of the positioning sensor; and
wherein the processor is configured to generate an instruction to turn off the positioning sensor or to cause the data processing procedure not to consider the second data during a period in which the first data indicate that the vehicle is in a closed environment.

9. The sensor data manager of claim 1,
wherein the first data represent a time; and
wherein the processor is configured to generate an instruction to change the setting of the second sensor based on the time.

10. The sensor data manager of claim 9,
wherein the time corresponds to a period of darkness, and wherein the second sensor is a sensor that requires light for operation.

11. The sensor data manager of claim 1,
wherein the first data represent a time; and
wherein the processor is configured to generate an instruction to change the data processing procedure for the automated driving function based on the time.

12. The sensor data manager of claim 11,
wherein the processor is configured to determine the area of relevance of the second data by considering a location and/or an alignment/orientation of the vehicle on a multi-lane street, a current time, whether the field of view of a sensor is obstructed, the presence of a nearby object or obstacle, or a planned driving task.

13. The sensor data manager of claim 12,
wherein, when an object obstructs a long-range view from the vehicle, the processor is configured to determine the area of relevance for the driving operation to exclude an area obstructed by the object.

14. The sensor data manager of claim 13,
wherein, when a likelihood of a lane change is low, the processor is configured to determine the area of relevance for the driving operation to exclude an area in a lane other than the lane in which the vehicle is traveling.

15. The sensor data manager of claim 1, further comprising:
third data, representing an intended action of the vehicle;
wherein the processor is configured to determine the area of relevance for the driving operation by excluding from the area of relevance an area that does not correspond to a predicted future location of the vehicle based on the intended action.

16. The sensor data manager of claim 1,
wherein the instruction is a first instruction, and wherein the processor is further configured to:
determine a buffer duration based on the speed of the vehicle;
determine from the first data a time at which the relevance of the second data to the vehicle will increase;
generate a second instruction at a time before the buffer duration, wherein the second instruction is an instruction to change the setting of the second sensor or to change the data processing procedure for the second data.

17. The sensor data manager of claim 16,
wherein the processor is configured to determine the buffer duration based on the speed of the vehicle and a reaction time.

18. The sensor data manager of claim 1, wherein the first sensor or the second sensor is located externally to the vehicle, such as in another vehicle or a roadside unit (RSU), and the first data or the second data are wirelessly transmitted to the vehicle.

19. An advanced driver assistance system (ADAS) or an automatic driving system (AD), comprising the sensor data manager as claimed in claim 1.

20. A vehicle having the sensor data manager as claimed in claim 1.
